(19) United States
(12) Patent Application Publication
(10) Pub. No.: US 2018/0128927 A1
(43) Pub. Date: May 10, 2018

(54) Coded Signals for Marine Vibrators

(71) Applicant: PGS Geophysical AS, Oslo (NO)

(72) Inventor: Stig Rune Lennart Tenghamn, Houston, TX (US)

(73) Assignee: PGS Geophysical AS, Oslo (NO)

(21) Appl. No.: 15/727,338

(22) Filed: Oct. 6, 2017

Related U.S. Application Data
(60) Provisional application No. 62/409,957, filed on Oct. 19, 2016.

(51) Int. Cl. G01V 1/00; G01V 1/38

(52) U.S. Cl. CPC G01V 1/006; G01V 1/005; G01V 1/3843; G01V 2210/34; G01V 2210/1293; G01V 2210/1423; G01V 2210/127

(57) ABSTRACT

Embodiments may be directed to marine vibrators and associated methods that use appropriately selected composite code sequences. A method of seismic surveying may comprise operating a plurality of marine vibrators. At least one of the marine vibrators may repeatedly cycle through a plurality of composite code sequences that are unique to the at least one of the marine vibrators, wherein two or more of the marine vibrators operate contemporaneously for at least one output interval. The method may further comprise detecting seismic energy with one or more seismic sensors after the seismic energy has interacted with subsurface formations, wherein the seismic energy was emitted from the marine vibrators, wherein the detecting occurs while operating the plurality of marine vibrators.

### CROSS-REFERENCE TO RELATED APPLICATIONS

The present application claims the benefit of U.S. Provisional Application No. 62/409,957, filed Oct. 19, 2016, entitled “Coded Signals for Marine Vibrators,” the entire disclosure of which is incorporated herein by reference.

### BACKGROUND

Techniques for marine surveying include marine seismic surveying, in which geophysical data may be collected from below the Earth's surface. Seismic surveying has applications in mineral and energy exploration and production to help identify locations of hydrocarbon-bearing formations. Seismic surveying typically may include towing a seismic source below or near the surface of a body of water. One more “streamers” may also be towed through the water by the same or a different vessel. The streamers are typically cables that include a plurality of sensors disposed thereon at spaced apart locations along the length of each cable. Some seismic surveys locate sensors on ocean bottom cables or nodes in addition to, or instead of, streamers. The sensors may be configured to generate a signal that is related to a parameter being measured by the sensor. At selected times, the seismic source may be actuated to generate, for example, seismic energy that travels downwardly through the water and into the subsurface formations. Seismic energy that interacts with interfaces, generally at the boundaries between layers of the subsurface formations, may be returned toward the surface and detected by the sensors on the streamers. The detected energy may be used to infer certain properties of the subsurface formations, such as structure, mineral composition and fluid content, thereby providing information useful in the recovery of hydrocarbons.

Most of the seismic sources employed today in marine seismic surveying are of the impulsive type, in which efforts are made to generate as much energy as possible during as short a time span as possible. The most commonly used of these impulsive-type sources are air guns that typically utilize compressed air to generate a sound wave. Other examples of impulsive-type sources include explosives and weight-drop impulse sources. Another type of seismic source that may be used in seismic surveying includes marine vibrators, including hydraulically powered sources, electro-mechanical vibrators, electrical marine vibrators, and sources employing piezoelectric or magnetostrictive material.

Marine vibrators typically generate vibrations through a range of frequencies in a pattern known as a “sweep” or “chirp.” For example, a sweep may be generated in a frequency band of from about 10 Hz to about 100 Hz (or other suitable frequency band). The signal may then be correlated at the sensor to generate a pulse which should give the same result as using an impulsive-type source. The marine vibrators may be operated for an output interval (e.g., 5 seconds) followed by a listening interval (e.g., 5 seconds). If two different arrays of marine vibrators are operated in different frequency band, each array may be operated separately. For example, operating a first array for an output interval followed by a listening interval and then operating the second array for an output interval followed by a listening interval. Problems may occur if the marine vibrators are operated in the listening interval as it may be hard to distinguish seismic energy received directly from the marine vibrators with seismic energy from the marine vibrators that has interacted with subsurface formations. In addition, problems may also occur if the two different arrays are operated simultaneously as it may be hard to distinguish seismic energy from the different arrays as well as from different marine vibrators within each array.

### BRIEF DESCRIPTION OF THE DRAWINGS

These drawings illustrate certain aspects of some of the embodiments of the present disclosure and should not be used to limit or define the disclosure.

FIG. 1 illustrates an example embodiment of a marine seismic survey system using a marine vibrator.

FIG. 2 illustrates an example embodiment of an array of marine vibrators being towed through a body of water.

FIG. 3 illustrates an example embodiment of a seismic vibrator signal generator.

FIG. 4 illustrates an example embodiment of a signal detection device coupled to a seismic receiver.

FIG. 5 illustrates a graph of an autocorrelation maximal-length-type code sequence.

FIG. 6 illustrates a graph of a cross-correlation for maximal-length-type code sequence.

FIG. 7 illustrates a graph of an amplitude spectrum for a maximal-length-type sequence.

FIG. 8 illustrates a graph of an autocorrelation Gold-type code sequence.

FIG. 9 illustrates a graph of a cross-correlation Gold-type code sequence.

FIG. 10 illustrates a graph of an amplitude spectrum for a Gold-type code sequence.

FIG. 11 illustrates a graph of an auto-correlation Kasami-type code sequence.

FIG. 12 illustrates a graph of a cross-correlation Kasami-type code sequence.

FIG. 13 illustrates a graph of an amplitude spectrum Kasami-type code sequence.

FIG. 14 illustrates an example embodiment of a feedback circuit.

### DETAILED DESCRIPTION

It is to be understood the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Embodiments may be directed to marine vibrators and associated methods. At least one embodiment may be directed to a marine vibrators that use appropriately selected composite code sequences. Advantageously, use of these composite code sequences may enable generation of seismic signals that approximate background noise in spectral statistics. Examples of some useful code sequences that may be used for the marine vibrators may include, but are not limited to, maximum-length-type code sequences, Gold-type code sequences, or Kasami-type code sequences. By use of appropriately selected composite code sequences marine vibrators may be operated continuously without the need for listening time. For example, the marine vibrators may be operated with substantially no listening time, for example, less than 0.5 seconds, less than 0.1 seconds, or even less. In addition, two or more marine vibrators, or two or more arrays of marine vibrators, may be operated simultaneously using different code sequences that are unique for each marine vibrator or array of marine vibrators.

It is not only the possible environmental benefits of using marine vibrators that makes it desirable to adapt marine vibrators to use in marine seismic surveying. By having a marine vibrator that may generate arbitrary types of signals there may be substantial benefit to using seismic energy signals that are more “intelligent” than conventional sweeps. Such a marine vibrator would be able to generate signals having more of the characteristics of background noise and thus be more immune to interference from noise and at the same reduce their environmental impact. Generating arbitrary signals in the seismic frequency band may include using a source which has a high efficiency to make the marine vibrator controllable within the whole seismic frequency band of interest. Combining several marine vibrators that are individually controllable, with more sophisticated signal schemes, such as the composite code sequences, may make it possible to generate seismic signals from several discrete marine vibrators at the same time that have a very low cross correlation, thereby making it possible to increase the efficiency acquiring seismic data. Marine vibrators known in the art typically have a resonance frequency that is higher than the upper limit of ordinary seismic frequencies of interest. This means that the vibrator energy efficiency may be very low, principally at low frequencies but generally throughout the seismic frequency band, and such vibrators may be difficult to control with respect to signal type and frequency content. Conventional marine vibrators may be subject to strong harmonic distortion, which may limit the use of more complex signals.

A method of seismic surveying may comprise operating a plurality of marine vibrators. At least one of the marine vibrators may repeatedly cycle through a plurality of composite code sequences that are unique to the at least one of the marine vibrators. In at least one embodiment, the plurality of composite codes may comprise a pair of composite code sequences that are unique to the at least one of the marine vibrators such that the at least one of the marine vibrators alternates between the pair of composite code sequences. In at least one embodiment, two or more of the marine vibrators operate contemporaneously for at least one output interval. The method may further comprise detecting seismic energy with one or more seismic sensors after the seismic energy has interacted with subsurface formations. The seismic energy may be emitted from the marine vibrators, wherein detection occurs while operating the plurality of marine vibrators.

A method of manufacturing a geophysical data product may include towing a plurality of marine vibrators in a body of water and operating the plurality of marine vibrators in a frequency band of from about 1 Hz to about 300 Hz. At least one of the marine vibrators may repeatedly cycle through a plurality of composite code sequences that are unique to the at least one of the marine vibrators. In at least one embodiment, the plurality of composite codes may comprise a pair of composite code sequences that are unique to the at least one of the marine vibrators such that the at least one of the marine vibrators alternates between the pair of composite code sequences. In at least one embodiment, two or more of the marine vibrators operate contemporaneously for at least one output interval, wherein two or more of the marine vibrators operate contemporaneously for at least one output interval. The method of manufacturing a geophysical data product may further comprise detecting seismic energy with one or more seismic sensors after the seismic energy has interacted with subsurface formations. The seismic energy may be emitted from the marine vibrators, wherein the detecting occurs while operating the plurality of marine vibrators. Additionally, the method may comprise recording the detected seismic energy on one or more non-transitory, tangible computer-readable media which may create a geophysical data product.

A system for seismic surveying may include a plurality of marine vibrators, wherein at least one of the marine vibrators is operable to emit composite code sequences that are unique. The system may further include a signal generator operable to generate the composite code sequences that are unique and a control system operable to actuate the marine vibrators contemporaneously for at least one output interval and measure seismic data from the marine vibrators.

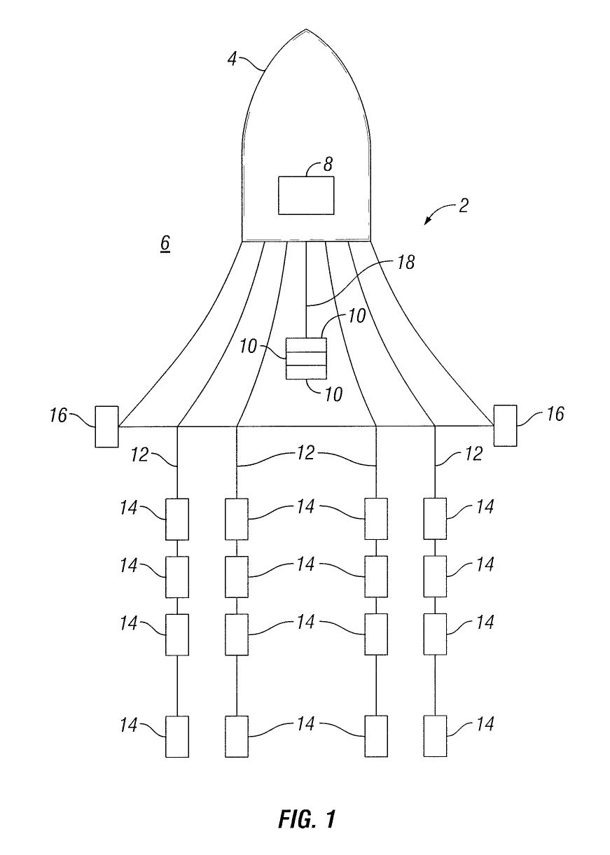

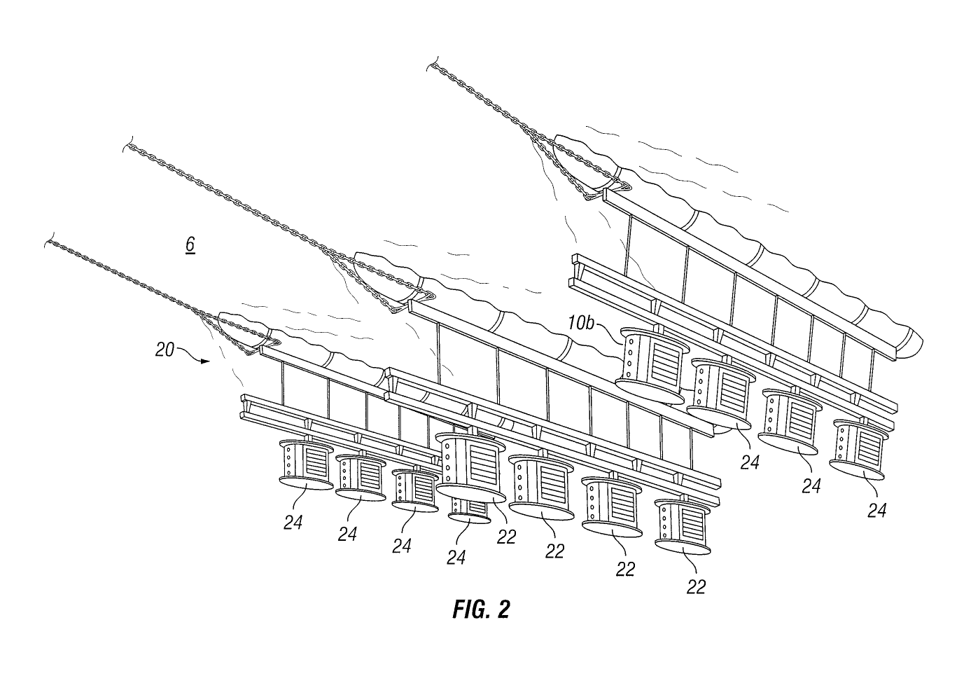

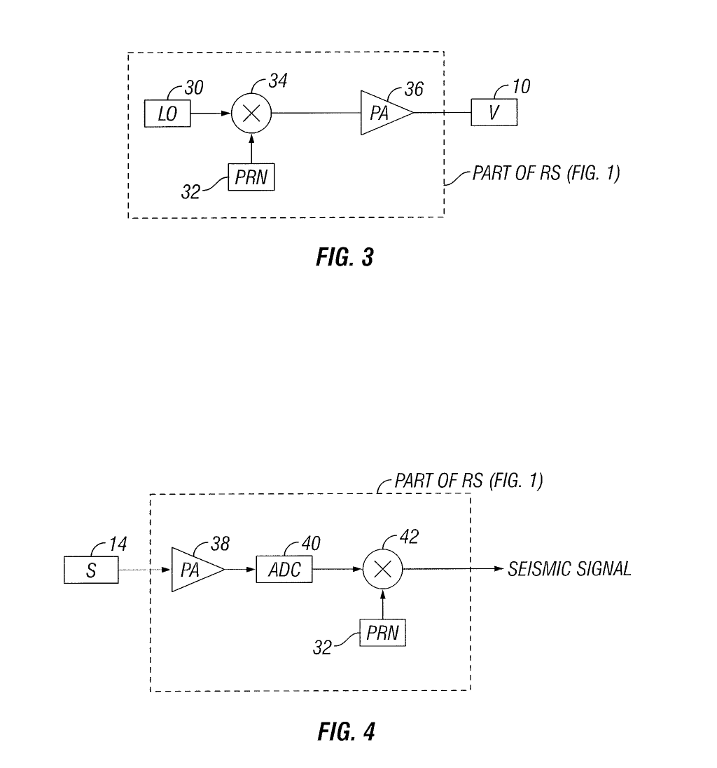

FIG. 1 illustrates a marine seismic survey system 2 in accordance with example embodiments. Marine seismic survey system 2 may include a survey vessel 4 that moves along the surface of a body of water 6, such as a lake or ocean. Survey vessel 4 may include thereon equipment, shown generally at 8 and collectively referred to herein as a “control system.” The control system 8 may include devices (none shown separately) for actuating marine vibrators 10 at selected times. Control system 8 may also include devices (none shown separately) for detecting and making a time indexed record of signals generated by each of seismic sensors (explained further below) and/or for determining the geodetic position of survey vessel 4 and the various seismic sensors. Control system 8 may be located at one location, for example, on survey vessel 4, as shown on FIG. 1, or may be at one or more locations in the marine seismic survey system 2. For example, control system 8 may include one or more processors (not shown).

As illustrated, survey vessel 4 may tow sensor streamers 12. Sensor streamers 12 may be towed in a selected pattern in the body of water 6 by survey vessel 4 or a different vessel. As illustrated, sensor streamers 12 may be laterally spaced apart behind survey vessel 4. “Lateral” or “laterally,” in the present context, means transverse to the direction of the motion of survey vessel 4. Sensor streamers 12 may each be formed, for example, by coupling a plurality of streamer segments (none shown separately). Sensor streamers 12 may be maintained in the selected pattern by towing equipment 16, such as paravanes or doors that provide lateral force to spread sensor streamers 12 to selected lateral positions with respect to survey vessel 4. Sensor streamers 12 may have a length, for example, in a range of from about 2,000 meters to about 12,000 meters or longer. The configurations of sensors streamers 12 on FIG. 1 is provided to illustrate an example embodiment and is not intended to limit the present disclosure. It should be noted that, while the present example, shows four of the sensor streamers 12, the present disclosure is applicable to any number of sensor streamers 12 towed by survey vessel 4 or any other vessel. For example, in some embodiments, more or less than four of the sensor streamers 12 may be towed by survey vessel 4, and sensor streamers 12 may be spaced apart laterally, vertically, or both laterally and vertically.

Sensors streamers 12 may include seismic sensors 14 thereon at spaced apart locations. Seismic sensors 14 may be any type of seismic sensors known in the art, including hydrophones, geophones, particle velocity sensors, particle displacement sensors, particle acceleration sensors, or pressure gradient sensors, for example. By way of example, seismic sensors 14 may generate response signals, such as electrical or optical signals, in response to detecting seismic energy emitted from marine vibrators 10 after the energy has interacted with the formations (not shown) below the water bottom. Signals generated by seismic sensors 14 may be communicated to control system 8. While not illustrated, seismic sensors 14 may alternatively be disposed on ocean bottom cables or subsurface acquisition nodes in addition to, or in place of, sensors streamers 12.

As illustrated in FIG. 1, survey vessel 4 or a different vessel may tow marine vibrators 10. Although only a single survey vessel 4 is shown, it should be understood that the marine vibrators may be towed by different survey vessels, for example, as desired for a particular application. Recording system 8 may be operable to actuate marine vibrators 10 contemporaneously for at least one output interval and measure seismic data from the marine vibrators 10 that is sensed by seismic sensors 14. It should also be noted that marine vibrators 10 may be operated independent of control system 8. Marine vibrators 10 may be operated at any suitable frequency band, for example, from about 1 Hertz (“Hz”) to about 300 Hz. A source cable 18 may couple the marine vibrators 10 to survey vessel 4. Source cable 18 may take drag forces and also may include electrical conductors (not shown separately) for transferring electrical current from control system 8 on survey vessel 4 to marine vibrators 10. Source cable 18 may also include signal cables or fibers for transmitting signals to and/or from marine vibrators 10 to control system 8. Source cable 18 may also include strength members (not shown separately) for transmitting towing force from survey vessel 4 to marine vibrators 10. Source cable 18 may also contain conductors for transmitting air to marine vibrators 10 for pressure compensation, for example. Source cable 18 may have a length in a range of about 200 meters to about 2,000 meters or longer, for example. In some embodiments, source cable 18 may be about 900 meters long and have an outer diameter of about 65 millimeters. In some embodiments, source cable 18 may be relatively parallel to the surface of the body of water 6, while in other embodiments, source cable 18 may utilize depth control mechanisms, for example, to locate more than one of marine vibrators 10 at a plurality of different depths.

In contrast to impulsive-type sources which transmit energy during a very limited amount of time, marine vibrators 10 may have a reduced environmental impact due the distribution of energy over time. In particular, marine vibrators 10 may have a reduced peak amplitude of the transmitted seismic signal during a seismic survey with little or no reduction in the data quality. For example, by using marine vibrators 10 with, for example, a five-second sweep, instead of an impulsive-type source such as an air gun, the peak amplitudes may be reduced by as much as 30 dB or even more. If pseudo-noise source sequences are used to not only spread out the energy over time but also the frequency over time, the peak amplitudes may be reduced by another 20 dB or even more. In some embodiments, the peak amplitudes may be in the range of about 10 dB to about 40 dB.

Referring now to FIG. 2, an array 20 of one or more low frequency marine vibrators 22 and one or more high frequency marine vibrators 24 is illustrated in accordance with example embodiments. FIG. 2 illustrates array 20 towed through body of water 6. The array 20 may be used with a marine seismic survey system (e.g., marine seismic survey system 2 on FIG. 1), for example, the marine vibrator 10 on FIG. 1 may comprise the one or more low frequency marine vibrators 22 and/or the one or more high frequency marine vibrators 24. Array 20 of low frequency marine vibrators 22 and high frequency marine vibrators 24 may be used, for example, to generate a desired acoustic output. Correlation noise may be low as the low frequency marine vibrators 22 and high frequency marine vibrators 24 may use different frequencies. In some embodiments, two or more of the low frequency seismic vibrators 22 and high frequency marine vibrators 24 may be used contemporaneously or even simultaneously. As would be understood by one of ordinary skill in the art with the benefit of this disclosure, energy emitted from the array 20 would appear in the formations below the water bottom as if it emanated from a point source when the dimensions of array 20 are on the order of, for example, 30 meters or less. The one or more low frequency marine vibrators 22 may be operated as an array (sub-array) while the one or more high frequency marine vibrators 24 may be operated as a separate array. The one or more low frequency marine vibrators 22 may operate, for example, in a frequency band of about 5 Hz to about 25 Hz and the one or more high frequency vibrators 24 may operate, for example, in a frequency band of about 25 Hz to about 100 Hz. In some embodiments, the one or more of the low frequency marine vibrators 22 and the one or more of the high frequency marine vibrators 24 may each have two resonance frequencies. Additionally, the one or more of the low frequency marine vibrators 22 may operate at two or more octaves lower than the one or more of the high frequency marine vibrators 24. Embodiments may include use of a nonlinear sweep to enhance output of particular frequency bands, or the number of low frequency marine vibrators 22 and high frequency marine vibrators 24 may be increased to thereby avoid the frequency bands where the amplitude spectrum is below a specified value. In examples, the frequency band may be divided between two or more sources. Each source may further comprise different frequency bands, which may range between about 1 Hz to about 200 Hz.

The low frequency marine vibrators 22 and/or high frequency marine vibrators 24 may operate and function together as unique pairs and/or individually as separate sources. In embodiments, the low frequency marine vibrators 22 and the high frequency marine vibrators 24 may repeatedly cycle through composite code sequences. In some embodiments, the composite codes for the low frequency marine vibrators 22 may be unique from the high frequency marine vibrators 24. In some embodiments, composite code sequences may comprise a pair of composite code sequences that are unique. In some embodiments, each of the low frequency marine vibrators 22 and the high frequency marine vibrators 24 in the array 20 may alternate between a pair of composite codes that is unique for that particular marine vibrator. Suitable composite code sequences may include, but are not limited to, maximal-length-type code sequences, a Gold-type code sequences, and/or a Kasami-type code sequences. In array 20, the low frequency marine vibrators 22 and the high frequency marine vibrators 24 may be disposed with a small distance from each other to be considered a point source. Additionally, low frequency marine vibrators 22 and the high frequency marine vibrators 24 may operate with different pairs of composite code sequences, which may allow an operator to add greater space between low frequency marine vibrators 22 and the high frequency marine vibrators 24.

In using the system shown in FIG. 1, it may be advantageous to use more than one of marine vibrators 10 substantially contemporaneously or even simultaneously in order to increase the efficiency with which seismic signals related to subsurface formations (below the water bottom) may be obtained. Seismic signals detected by each of seismic sensors 14 in such circumstances may result in seismic energy being detected that results from an individual one of marine vibrators 10 in operation at the time of signal recording. Operating marine vibrators 10 contemporaneously may include driving each of marine vibrators 10 with composite code sequence that may be substantially uncorrelated with the signal used to drive each of the other marine vibrators 10. By using such driver signals to operate each of marine vibrators 10, it may be possible to determine that portion of the detected seismic signals that originated at each of the marine vibrators 10.

A type of driver signal to operate marine vibrator 10 in some examples is known as a “direct sequence spread spectrum” signal. Direct sequence spread spectrum (“DSSS”) signal generation uses a modulated, coded signal with a “chip” frequency selected to determine the frequency content (bandwidth) of the transmitted signal. A “chip” means a pulse shaped bit of the direct sequence coded signal. Direct sequence spread spectrum signals also may be configured by appropriate selection of the chip frequency and the waveform of a baseband signal so that the resulting DSSS signal has spectral characteristics similar to background noise. The foregoing may make DSSS signals particularly suitable for use in environmentally sensitive areas.

An example implementation of a signal generator to create particular types of vibrator signals is illustrated schematically in FIG. 3. A local oscillator 30 generates a baseband carrier signal. In one example, the baseband carrier signal may be a selected duration pulse of direct current, or continuous direct current. In other examples, the baseband signal may be a sweep or chirp as used in conventional vibrator-source seismic surveying, for example traversing a frequency band from about 1 Hz to about 300 Hz (or from about 10 Hz to about 150 Hz). A pseudo random number (“PRN”) generator 32 (or code generator) generates a sequence of numbers +1 and −1 according to certain types of encoding schemes, described below. The PRN generator 32 output and the local oscillator 30 output may be mixed in a modulator 34. Output of modulator 34 may be conducted to a power amplifier 36, the output of which ultimately operates one of the marine vibrators 10. A similar configuration may be used to operate each of a plurality of marine vibrators 10 as shown in FIG. 1.

Signals generated by the device shown in FIG. 3 may be detected using a device as shown in FIG. 4. Each of seismic sensors 14 may be coupled to a preamplifier 38, either directly or through a suitable multiplexer (not shown). Output of preamplifier 38 may be digitized in an analog to digital converter (“ADC”) 40. Modulator 42 mixes the signal output from ADC 40 with the identical code produced by PRN generator 32.

The theoretical explanation of DSSS signal generation and detection may be understood as follows. The DSSS signal, represented by uᵢ, may be generated by using a spectrum “code sequence”, represented by cᵢ and generated, for example, by the PRN generator 32, to modulate a baseband carrier. A baseband carrier may be generated, for example, by the local oscillator 30. The baseband carrier has a waveform represented by ψ(t). The code sequence has individual elements cᵢⱼ (called “chips”) each of which has the value +1 or −1 when 0≤j<N and 0 for all other values of j. If a suitably programmed PRN generator 32 is used, the code may repeat itself after a selected number of chips. N is the length (the number of chips) of the code before repetition takes place. The baseband carrier may be preferably centered in time at t=0 and its amplitude may be normalized so that at time zero the baseband carrier amplitude may be equal to unity, or (ψ(0)=1). The time of occurrence of each chip i within the composite code may be represented by Tc. The signal used to drive each marine vibrator 10 may thus be defined by the expression:

uᵢ(t)Σ_{j=-∞}^{∞}cᵢ^{j}ψ(t−jT_{c}) (Eq. 1)

The waveform uᵢ(t) is deterministic, so that its autocorrelation function is defined by the expression:

Rᵤ(τ)=∫_{-∞}^{∞}u(t)u(t−τ)dt (Eq. 2)

where τ is the time delay between correlated signals. The discrete periodic autocorrelation function for a=aⱼ is defined by

$${R}_{a , a} ( l ) = \{ \begin{matrix}{\sum }_{j = 0}^{N - 1 - l} {a}_{j} {a}_{j + l} , & 0 \leq l \leq N - 1 \\ {\sum }_{j = 0}^{N - 1 + l} {a}_{j - l} {a}_{j} , & 1 - N \leq l < 0 \\ 0 , & \vert l \vert \geq N\end{matrix} \qquad ( Eq . 3 )$$

Using Eq. 2 it may be possible to determine the cross correlation between two different signals by the expression:

Rᵤ(τ)=∫_{-∞}^{∞}u(t)u(t−τ)dt (Eq. 4)

The discrete periodic cross-correlation function for a=aⱼ and b=bⱼ, is defined by the expression:

$${R}_{a , b} ( l ) = \{ \begin{matrix}{\sum }_{j = 0}^{N - 1 - l} {a}_{j} {b}_{j + l} , & 0 \leq l \leq N - 1 \\ {\sum }_{j = 0}^{N - 1 + l} {a}_{j - 1} {b}_{j} , & 1 - N \leq l < 0 \\ 0 , & \vert l \vert \geq N\end{matrix} \qquad ( Eq . 5 )$$

The signal detected by each of marine vibrators 10 (Referring to FIG. 1) may be include seismic energy originating from the one of the marine vibrators 10 for which seismic information may be obtained, as well as several types of interference, such as background noise, represented by n(t), and from energy originating from the other vibrators transmitting at the same time, but with different direct sequence spread spectrum codes (represented by cₖ(t) wherein k≠i). The received signal at each marine vibrator 10, represented by xᵢ(t), the signal detected by each of the marine vibrator 10 (Referring in FIG. 1) in a system with M marine vibrators 10 operating at the same time, may be described by the expression:

xᵢ(t)=Σⱼ₌₁^{M}uⱼ(t)+n(t) (Eq. 6)

The energy from each of marine vibrators 10 may penetrate the subsurface geological formations below the water bottom, and reflected signals from the subsurface may be detected at each of marine vibrators 10 after a “two way” travel time depending on the positions of the particular one of marine vibrators 10 and seismic sensors 14 and the seismic velocity distribution in body of water 6 and in the subsurface below the water bottom. If the transmitted vibrator signal for direct sequence spread spectrum code i occurs at time t=t₀, then the received signal resulting therefrom occurs at time t=τₖ+lₖT_{c}+t₀ after the transmission, wherein lₖ=any number being an integer and τₖ=the misalignment between the received signal and the chip time T_{c}. The received signal may be mixed with the identical code sequence used to produce each vibrator's output signal, uᵢ(t₀), as shown in FIG. 4. Such mixing may provide a signal that may be correlated to the signal used to drive each particular one of the marine vibrators 10. The mixing output may be used to determine the seismic response of the signals originating from each of marine vibrators 10. The foregoing may be expressed as follows for the detected signals:

$${y}_{i} ( {τ}_{i} + {l}_{i} {T}_{c} + {t}_{0} ) = {u}_{i} ( {t}_{0} ) {x}_{i} ( {τ}_{i} + {l}_{i} {T}_{c} + {t}_{0} ) = {u}_{i} ( 0 ) {x}_{i} ( {τ}_{i} + {l}_{i} {T}_{c} ) = {u}_{i} ( 0 ) ( {\sum }_{k = 1}^{K} {u}_{k} ( {τ}_{k} + {l}_{k} {T}_{c} ) + n ( t ) ) = {u}_{i} ( τ + {l}_{i} {T}_{c} ) {u}_{i} ( 0 ) + {\sum }_{k = 1 , k \neq i}^{M} {u}_{k} ( {τ}_{k} + {l}_{k} {T}_{c} ) {u}_{i} ( 0 ) + {u}_{i} ( t ) n ( t ) \qquad ( Eq . 7 )$$

Mixing (FIG. 4) the detected signal with the code sequence results in a correlation. The result of the correlation is:

R_{yu}_{ᵢ}(τᵢ+lᵢT_{c})=Σⱼ₌₀^{N-1}ψ(0)ψ(τᵢ)cᵢ^{j}cᵢ^{j+l}+Σⱼ₌₀^{N-1}[ψ(0)Σ_{k=1,k≠i}^{M}ψ(τₖ)cᵢ^{j}cₖ^{j+l}^{ₖ}]+uᵢ(t)n(t) (Eq. 8)

Simplification of the above expressions provides the following result:

$${R}_{{yu}_{i}} ( {τ}_{i} + {l}_{i} {T}_{c} ) = {d}_{i} ψ ( 0 ) ψ ( {τ}_{i} ) {\sum }_{j = 0}^{N - {l}_{i} - 1} {c}_{i}^{j} {c}_{i}^{j + l} + ψ ( 0 ) {\sum }_{k = 1 , k \neq i}^{M} [ {\sum }_{j = 0}^{N - lk - 1} ψ ( {τ}_{k} ) {c}_{i}^{j} {c}_{k}^{j + {l}_{k}} ] + {u}_{i} ( t ) n ( t ) = ψ ( 0 ) ψ ( {τ}_{i} ) {R}_{{u}_{i} {u}_{i}} ( {l}_{i} ) + ψ ( 0 ) {\sum }_{k = 1 , k \neq i}^{M} [ ψ ( {τ}_{k} ) {R}_{{u}_{i} {u}_{j}} ( {l}_{k} ) ] + {u}_{i} ( t ) n ( t ) \qquad ( Eq . 9 )$$

If R(0)=N and ψ(0)=1, the foregoing expression simplifies to:

$${R}_{{yu}_{i}} ( 0 ) = {ψ ( 0 )}^{2} {R}_{{u}_{i} {u}_{i}} ( 0 ) + ψ ( 0 ) {\sum }_{k = 1 , k \neq i}^{M} [ ψ ( {τ}_{k} ) {R}_{{u}_{i} {u}_{j}} ( {l}_{k} ) ] + {u}_{i} ( t ) n ( t ) = \underbrace{N}_{data} + {\sum }_{k = 1 , k \neq i}^{M} [ {ψ ( {τ}_{k} )}_{\underbrace{cross\_correlations}} {R}_{{u}_{i} {u}_{j}} ( {l}_{k} ) ] + {{u}_{i} ( t ) n ( t )}_{\underbrace{background\_noise}} \qquad ( Eq . 10 )$$

Equation (10) shows that it may be possible to separate the direct spread spectrum sequence signals corresponding to each code sequence from a signal having components from a plurality of code sequences. N may represent the autocorrelation of the transmitted signal, and by using substantially orthogonal or uncorrelated spread spectrum signals to drive each of marine vibrators 10, the cross correlation between them may be very small compared to N. Another possible advantage may be that any noise which appears during a part of the time interval when the seismic signals are recorded may be averaged out for the whole record length and thereby attenuated, as may be inferred from Equation 10.

In a practical implementation, a seismic response of the subsurface to imparted seismic energy from each of marine vibrators 10 may be determined by cross correlation of the detected seismic signals with the signal used to drive each of marine vibrators 10, wherein the cross correlation includes a range of selected time delays, typically from zero to an expected maximum two way seismic energy travel time for formations of interest in the subsurface (usually about 5 to about 6 seconds). Output of the cross correlation may be stored and/or presented in a seismic trace format, with cross correlation amplitude as a function of time delay.

The baseband carrier has two properties that may be optimized. The baseband carrier may be selected to provide marine vibrator 10 output with suitable frequency content and an autocorrelation that has a well-defined correlation peak. Equation (10) also shows that the length of the direct spread spectrum sequence may affect the signal to noise ratio of the signal from marine vibrator 10. The correlation peaks resulting from the cross correlation performed as explained above will increase linearly with the length of (the number of chips) the code sequence. Larger N (longer sequences) may improve the signal to noise properties of the signal from marine vibrator 10.

By using appropriately selected code sequences, it may be possible to generate seismic signals that approximate background noise in spectral statistics. Some useful sequences that may be used for a plurality of marine vibrators 10 may be composite code sequences which may comprise maximal-length-type code sequences, Gold-type code sequences, or Kasami-type code sequences. In examples, a designated one of marine vibrator 10 may repeated cycle through a plurality of composite code sequences while one or more other of marine vibrators 10 may repeatedly cycle through additional composite code sequences, wherein the composite code sequences and the additional composite codes sequences are unique from one another. In examples, a designated one of marine vibrator 10 may alternate between a first pair of composite code sequences while one or more other of marine vibrators 10 may alternate between a second pair of composite code sequences, wherein the first pair and second pair are unique from one another. Additionally, each of marine vibrators 10 may emit composite code sequences, including maximal-length-type code sequences, Gold-type code sequences, or Kasami-type code sequences, in any order and at any time frame chosen by an operator.

Maximal-length-type code sequences may be a type of cyclic code that are generated using a linear shift register which has n stages connected in series, with the output of certain stages added modulo-2 and fed back to the input of the shift register. The name maximal-length-type code sequence derives from the fact that such sequence is the longest sequence that may be generated using a shift register. Mathematically the sequence may be expressed by the polynomial h(x)

h(x)=h₀xₘ+h₁xₘ₋₁+ . . . +hₙ₋₁x+hₙ (Eq. 11)

For 1≤j<m, then hⱼ=1 if there is feedback at the j-th stage, and hⱼ=0 if there is no feedback at j-th stage. h₀=hₘ=1. Which stage hⱼ that should be set to one or zero is not random but should be selected so that h(x) becomes a primitive polynomial. “Primitive” means that the polynomial h(x) cannot be factored. The number of chips for a maximum length sequence is given by the expression N=2ⁿ−1, where n represents the number of stages in the shift register. The maximum length sequence has one more “1” than “0.” The number of ones in a sequence equals the number of zeros within one chip. For a 1023-chip code there are 512 ones and 511 zeros. Consider a code implementation in which a one is represented by a positive voltage +V, and a zero by a negative voltage −V. The amount of offset over the code length is proportional to the inverse of the code length, or V/(2ⁿ−1). Similarly, when a code sequence biphase modulates a carrier, the residual carrier component is down by a factor (2ⁿ−1)⁻¹. Thus, the modulator may be important in carrier suppression but the codes may be capable of supporting the amount of suppression required. For example, when carrier suppression is about 30 dB, the shortest code usable is 1000 chips.

Statistical distribution of ones and zeros is well defined and constant. Relative positions of the runs vary from code sequence to code sequence, but the number of each run length may not. Autocorrelation of a maximal-length-type code sequence may be such that for all values of phase shift the correlation value is −1, except for the 0±1 chip phase shift area, in which correlation varies linearly from the −1 value to 2ⁿ−1 (the sequence length). A 1023-chip maximal code (2¹⁰−1), therefore, has a peak to minimum autocorrelation value of 1024 and a range of 30.1 dB. A modulo-2 addition of a maximal linear code with a phase-shifted replica of itself results in another replica with a phase shift different from either of the originals.

Every possible state, or n-tuple, of a given n-stage generator exists at some time during the generation of a complete code cycle. Each state exists for one and only one clock interval. A shift register sequence generator consists of a shift register working in conjunction with appropriate logic, which feeds back a logical combination of the state of two or more of its stages to its input. The output of a sequence generator, and the contents of its n stages at any sample (clock) time, is a function of the outputs of the stages fed back at the preceding sample time.

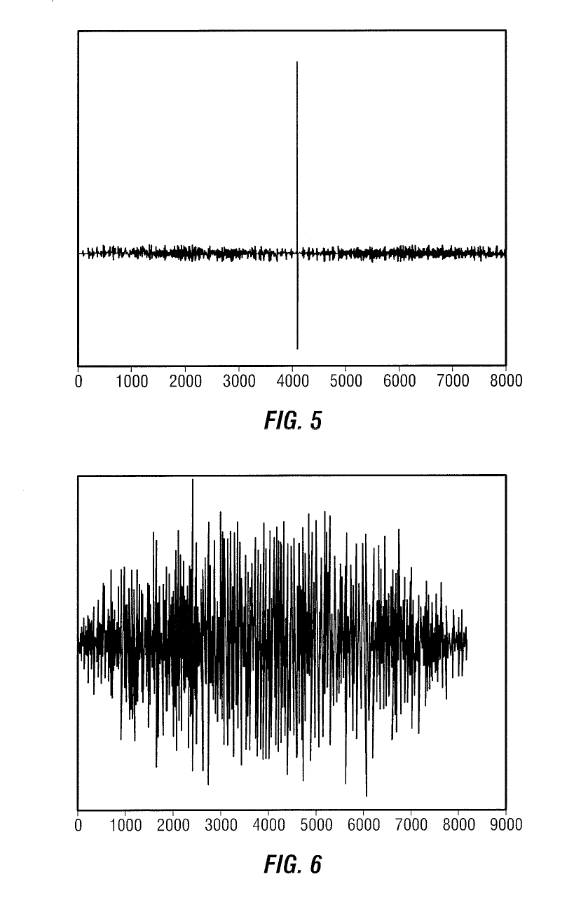

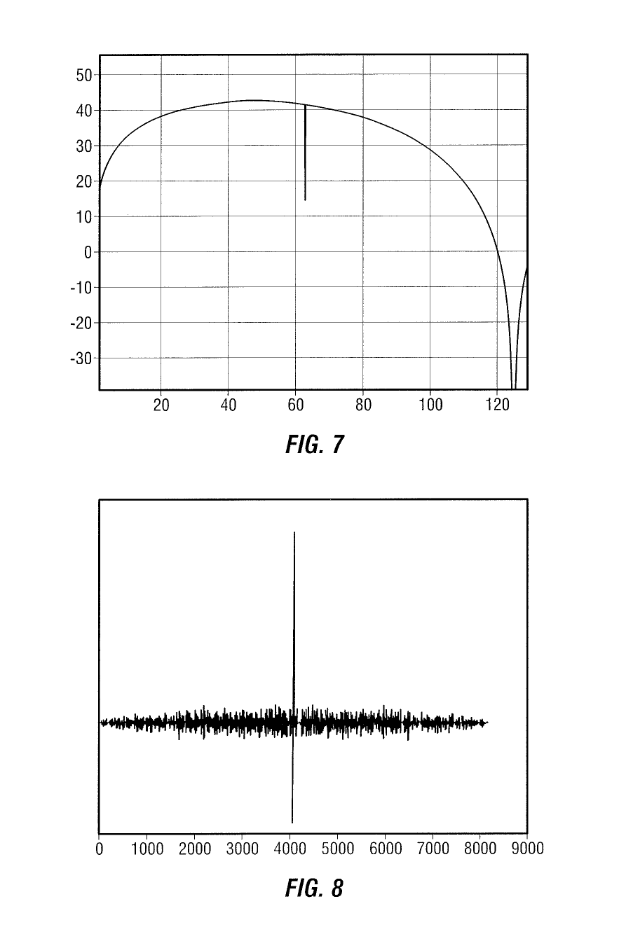

FIGS. 5-7 illustrate two maximal-length-type code sequences that may be created with polynomials: [4 9] and [3 4 6 9]. They may be bi-phase modulated to have zero amplitude at 0 Hz frequency. As illustrated in FIGS. 5-7, maximum length sequences may comprise two good cross correlation properties. However, it may be difficult to find a group of composite code sequences that may have good cross correlation properties. Composite code sequences may be constructed to produce good cross correction properties. Composite code sequences constructed in this way comprise properties that may be advantageous. For example, Gold-type code sequences, though constructed from maximal sequences, might not be maximal, but may provide advantageous properties. In some embodiments, the Gold-type code sequences allow construction of families of 2ⁿ−1 codes from pairs of n-stage shift registers in which all codes have well-defined correlation characteristics. Gold-type code sequence generators may be useful because of the large number of code sequences they supply, although they require only one pair of feedback tap sets. Additionally, these composite code sequences may need a few sets of feedback taps. Thus, the possibility of using a pair of single-tap feedback while retaining the capacity to generate a large number of codes is present. Gold-type code sequences may be generated by modulo-2 addition of a pair of maximal linear sequences. The code sequences may be added chip by chip by synchronous clocking. The codes themselves may be the same length. Thus, the two code generators maintain the same phase relationship, and the codes generated may be the same length as the two base codes which may be added together, but are non-maximal. The shift-and-add property of maximal sequences illustrate that any maximal sequence added to a phase-shifted replica of itself (any integral number of bits) may produce a different phase shift as an output.

Gold-type code sequences may be sets of non-maximal linear codes whose correlation properties may be uniform and well defined over the entire set. Two other code types have been advanced to serve in similar functions to Gold-type code sequences. These are the Kasami-type code sequences and the Bent-type code sequences. Both have lower cross-correlation bounds than Gold-type code sequences. While Gold-type code sequences have cross-correlation bounded at 2^{(N+1/2)}+1 or 2^{(N+2/2)}−1, the Bent code sequences and Kasami-type code sequences cross-correlation bound is 2^{(N+1/2)}+1. For example, a 1023-chip Gold-type code sequence set may have a cross-correlation bound of 63, while either Bent code sequences or Kasami-type code sequences sets may have their bound at 33, a difference of approximately 3 dB. However, the size of the Bent code sequences and Kasami-type code sequences sets may be much smaller than that of Gold-type code sequence sets, each set has 2^{N}+1 codes, while the Bent code sequences and Kasami-type code sequences comprise 2^{N/2} codes a piece. Thus the Bent code sequences and Kasami-type code sequences may not be useful as the Gold-type code sequences in multiple-access applications where large numbers of users may be accommodated. It should be noted that the Bent code sequences are nonlinear codes. If the numbers of multi-access applications are less than 10-20, Kasami-type code sequences may be used.

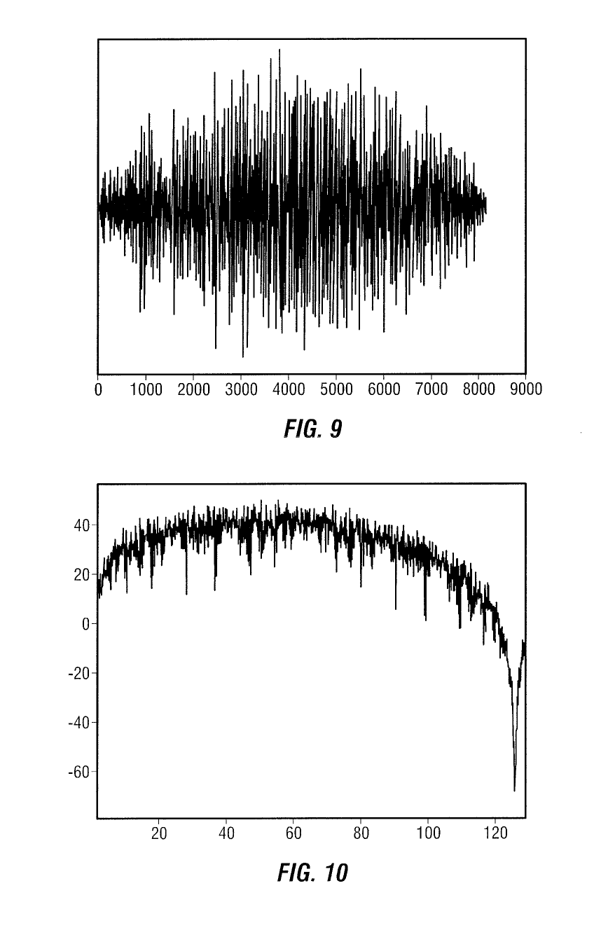

FIGS. 8-10 illustrate a first Gold-type code sequence and a second Gold-type code sequence that may be created from maximal-length-type code sequences. A first Gold-type code sequence and second Gold-type code sequence, which may create 2ⁿ⁻¹ codes. As illustrated, n=9 for a 511 code length. This may allow for the creation of 511 sequences that may have the same cross-correlation properties. This may create the opportunity to code each single source with a unique code. It should be noted that Gold-type code sequences may have 0.2-1.0 dB lower processing signal gain than the maximal-length-type code sequences.

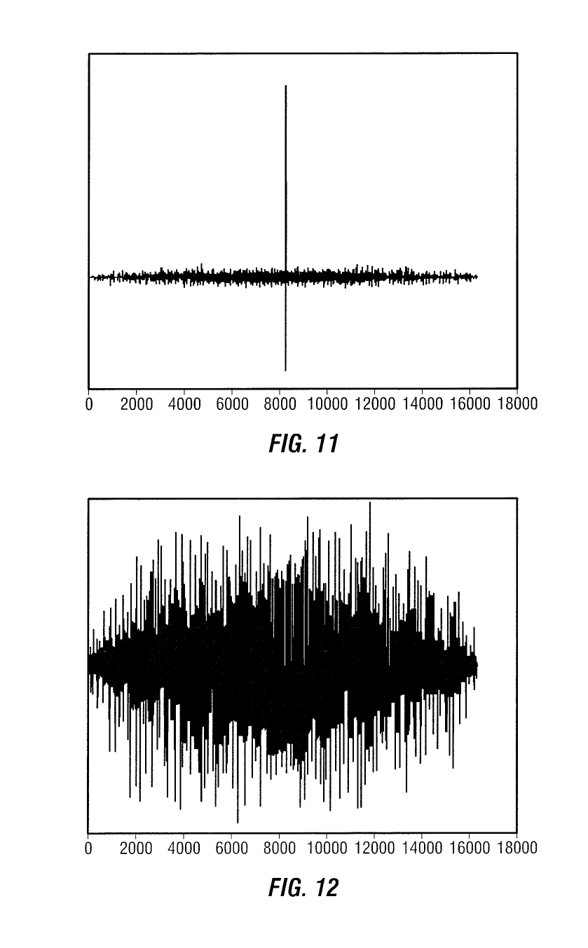

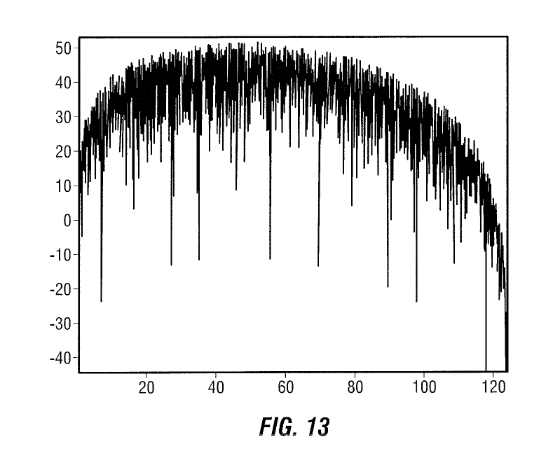

FIGS. 11-13 illustrate Kasami-type code sequences which may have good cross-correlation properties. Kasami-type code sequence sets may be used in some examples because they have very low cross correlation. There are two different sets of Kasami-type code sequences. A procedure similar to that used for generating Gold-type code sequences should generate the “small set” of Kasami-type code sequences with M=2^{n/2} binary sequences of period N=2ⁿ−1, where n is an even integer. Such procedure begin with a maximum length sequence, designated a, and forming the sequence a′ by decimating a by 2^{n/2}+1. It may be shown that the resulting sequence a′ is a maximum sequence with period 2^{n/2}−1. For example, if n=10, the period of a is N=1023 and the period of a′ is 31. Therefore, by observing 1023 bits of the sequence a′, one will observe 33 repetitions of the 31-bit sequence. Then, by taking N=2ⁿ−1 bits of sequences a and a′ it is possible to form a new set of sequences by adding, modulo-2, the bits from a and the bits from a′ and all 2^{n/2}−2 cyclic shifts of the bits from a′. By including a in the set, a result is a set of 2^{n/2} binary sequences of length N=2ⁿ−1. The autocorrelation and cross correlation functions of these sequences take on the values from the set {−1, −(2^{n/2}+1), 2^{n/2}−1}. The “large set” of Kasami-type code sequences again consists of sequences of period 2ⁿ−1, for n being an even integer, and contains both the Gold-type code sequences and the small set of Kasami-type code sequences as subsets.

In operation, marine vibrators 10 may typically operate to generate sweeps. For example, with reference to FIG. 2, array 20 may comprise low frequency marine vibrators 22 operating, for example, in a frequency band from about 5 Hz to about 25 Hz and high frequency marine vibrators 24 operating in a frequency band of from about 25 Hz to about 100 Hz. The low frequency marine vibrators 22 and high frequency marine vibrators 24 may operate in a flip flop mode, wherein there may be an output interval followed by a listening interval. In the output interval, the low frequency marine vibrators 22 and high frequency marine vibrators 24 may operate to generate acoustic energy. The output interval may range, for example, from about 1 second to about 20 seconds or longer. In one particular embodiment, the output interval may be about 5 seconds. In the listening interval, no acoustic energy may be generated and, instead, data may be collected, for example, using sensors. The listening interval may range, for example, from about 1 second to about 20 seconds or longer. In one particular embodiment, the listening interval may be about 5 seconds. This output and listening intervals may then be repeated at pre-selected intervals (e.g., 20 second intervals) where the low frequency marine vibrators 22 and high frequency marine vibrators 24 may operate in an alternating mode. Introducing the use of composite code sequences described above, the low frequency marine vibrators 22 and high frequency marine vibrators 24 may be utilized simultaneously and use a different correlator for the low frequency marine vibrators 22 and high frequency marine vibrators 24. The low frequency marine vibrators 22 and high frequency marine vibrators 24 may repeat their output sequence at pre-selected intervals (e.g., five to twenty seconds such as every ten seconds), which may double the data being acquired, as the listening interval may be reduced or even eliminated. In some embodiments, there may be substantially no listening interval, for example, the listening interval may be less than 0.5 seconds or less than 0.1. In examples, two composite code sequences (e.g., Kasami-type code sequences) may be implemented. The low frequency marine vibrators 22 and high frequency marine vibrators 24 may operate continuously alternating between a pair of composite code sequences. This may generate four times more data with low frequency marine vibrators 22 and high frequency marine vibrators 24 operating continuously. In other embodiments, the low frequency marine vibrators 22 and high frequency marine vibrators 24 may operate continuously with the low frequency marine vibrators 22 using composite code sequences that are unique from the composite code sequences for the high frequency marine vibrators 24. In yet other embodiments, the low frequency marine vibrators 22 and high frequency marine vibrators 24 may operate continuously with each of the low frequency marine vibrators 22 and high frequency marine vibrators 24 alternating between a pair of composite code sequences that are unique that the particular marine vibrator.

Composite code sequences within marine vibrators 10, such as low frequency marine vibrators 22 and high frequency marine vibrators 24, may originate from marine vibrators 10 where the phase may be controlled and may follow the sequences precisely as generated. The marine vibrators 10 may require a feedback system that may compensate for the open loop frequency response of the marine vibrators 10. This may be done with a feedback system based on iterative learning control (ILC) characterization, where the marine vibrators 10 may follow the shape of a reference signal. By way of example, an ILC characterization may be run for at least one of the marine vibrators 10.

By having these types of marine vibrators 10, multiple composite code sequences may be implemented for acquiring data. For example, each of the marine vibrators 10 may have two or more different composite code sequences, such as maximal-length-type code sequences, Kasami-type code sequences, or some other defined signal. For example, assuming two Gold-type code sequences per each of the marine vibrators 10, which may comprise twenty four Gold-type code sequences such as in array 20 with twelve marine vibrators 10 (e.g., four low frequency marine vibrators 22 and eight high frequency marine vibrators 24 as shown on FIG. 2). In an example of two arrays 20, forty eight Gold-type code sequences may be used. The composite code sequences for each of marine vibrators 10 may be different. Each sequence may be orthogonal with good cross-correlation properties. Each of marine vibrators 10 may be treated individually. Thus, marine vibrators 10 may be spread in an array (e.g., array 20 on FIG. 2) and correlate each of marine vibrators 10 with a unique composite code sequence. Each of marine vibrators 10 may operate continuously with its two designated composite code sequences. This may allow for the creation of new acquisition geometries to improve imaging of various geological structures. The number of marine vibrators 10 may increase or decrease since the number of composite code sequences may not be the limiting factor. If Kasami-type code sequences are used, there are fewer sequences to be used. The cross-correlation properties with Kasami-type code sequences, for example, may be up to 3 dB better compared to gold sequences. Allowing for smaller arrays of marine vibrators 10 (e.g., from 5 to 6 marine vibrators 10) together but with flexibility to position them in different locations of the spread.

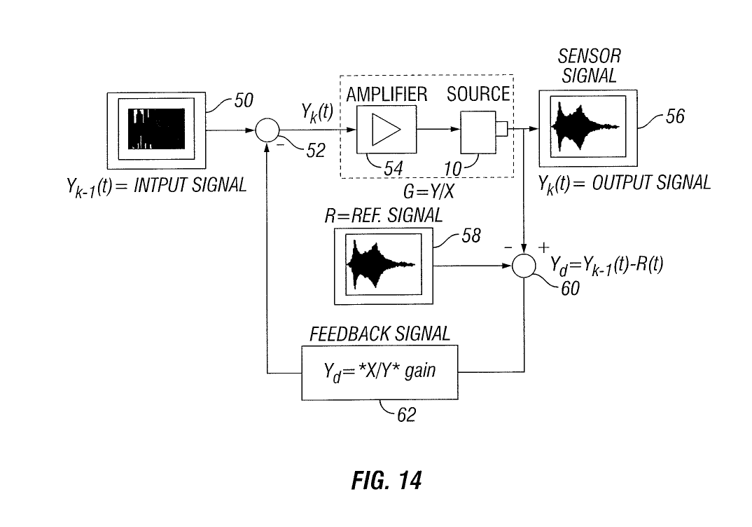

Referring to FIG. 14, a signal generator 50 may provide an initial form of the control signal to be generated by marine vibrator 10, for example, a linear sweep in the range of about 5 Hz to about 100 Hz. Signal generator 50 may form part of the control system 8 (Referring to FIG. 1). The functional components of the ILC characterization may also be performed on a general purpose computer forming part of control system 8 or on another computer. The output of signal generator 50 may be coupled to a summing amplifier 52 which also receives as input a correction signal generated by the ILC characterization. Summing amplifier 52 output, which may be referred to as a “corrected driver signal,” is coupled to a power amplifier 54 which drives the marine vibrator 10 to generate mechanical force and in turn seismic energy. A seismic sensor (e.g., seismic sensor 14 on FIG. 1) may record a measurement representative of the marine vibrator 10 output. The output signal Yₖ(t) of the seismic sensor 14 is shown at 56, and it represents the input signal convolved with the transfer function of the marine vibrator 10 at the point of measurement. The output signal 56 of the seismic sensor may be used, for example, as feedback in the iterative learning control characterization. In some embodiments, the output signal 56 may be summed or compared at 60 (e.g., determine a difference) with reference signal 58, which may be a desired marine vibrator 10 output signal. The sum or comparison of the current sensor output with the reference signal 58 may be combined to generate a new control signal in the form of feedback signal 62. Feedback signal 62 may be conducted to the summing amplifier 52 as explained above.

The ILC characterization may perform a method of tracking control for systems that work in a repetitive manner. In each of these tasks the system is required to perform the same action over and over again with high precision. By using information from previous repetitions, a suitable control action may found iteratively. The internal model principle yields conditions under which essentially perfect tracking can be achieved.

An inverted model of the system's transfer function may be made of marine seismic survey system 2. The degree of model accuracy selected may depend on the desired accuracy of the control. The same initial driver signal, referred to as X, may be repeated a selected number of times. After each iteration of the ILC characterization, the input driver signal u to the ILC characterization is updated. The ILC characterization uses a reference signal, designated R, to compare with the output Y from the vibrator system. The difference between the vibrator system output Y and the reference signal R, denoted by Y_{d}, can then be filtered by the inverted model (using, for example, a causal and a non-causal filter) and added to the input of the ILC system (e.g., at summing amplifier 52). The ILC system is iterated and if the ILC system's transfer function does not change faster than the update to the input driver signal the error e will decrease with respect to time.

The foregoing procedure may be implemented in the frequency domain. It has been observed that certain frequencies may be absent in the output in seismic sensors 14. Zero value at certain frequencies may make the ILC system unstable because the error function in the frequency domain includes division (which would be zero at the zero amplitude frequencies. By adding the output of the seismic sensor 14, the presence of zero amplitude frequencies in the combined sensor output is substantially eliminated, making implementation of the foregoing system stable in the frequency domain.

The methods and systems described above may be used to manufacture a geophysical data product indicative of certain properties of a subterranean formation. The geophysical data product may include geophysical data such as pressure data, particle motion data, particle velocity data, particle acceleration data, and any seismic image that results from using the methods and systems described above. The geophysical data product may be stored on a non-transitory computer-readable medium as described above. The geophysical data product may be produced offshore (i.e., by equipment on the survey vessel 4) or onshore (i.e., at a computing facility on land) either within the United States or in another country. When the geophysical data product is produced offshore or in another country, it may be imported onshore to a data-storage facility in the United States. Once onshore in the United States, geophysical analysis may be performed on the geophysical data product.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

What is claimed is:

1. A method of seismic surveying, comprising:
operating a plurality of marine vibrators, wherein at least one of the marine vibrators repeatedly cycle through a plurality of composite code sequences that are unique to the at least one of the marine vibrators, wherein two or more of the marine vibrators operate contemporaneously for at least one output interval; and
detecting seismic energy with one or more seismic sensors after the seismic energy has interacted with subsurface formations, wherein the seismic energy was emitted from the marine vibrators, wherein the detecting occurs while operating the plurality of marine vibrators.

2. The method of claim 1, wherein the plurality of composite code sequences comprises a pair of composite code sequences and the at least one of the marine vibrators alternates between the pair of composite code sequences.

3. The method of claim 1, further comprising towing the marine vibrators in a body of water.

4. The method of claim 1, wherein at least one of the composite code sequences comprises at least one sequence selected from the group consisting of a maximal-length-type code sequence, a Gold-type code sequence, and a Kasami-type code sequence.

5. The method of claim 1, wherein at least one of the composite code sequences comprises composite code sequences generated by a combination of maximal linear sequences.

6. The method of claim 1, wherein the marine vibrators comprise a plurality of low frequency marine vibrators and a plurality of high frequency marine vibrators, wherein the low frequency marine vibrators operate at a frequency band that is lower than a frequency band of the high frequency marine vibrators, wherein the low frequency marine vibrators repeatedly cycle through a plurality of composite code sequences that are unique to the low frequency marine vibrators.

7. The method of claim 6, wherein the low frequency marine vibrators and the high frequency marine vibrators operate contemporaneously.

8. The method of claim 1, further comprising running an iterative learning control characterization for at least one of marine vibrators.

9. The method of claim 8, wherein the iterative learning control characterization uses an output signal from a seismic sensor as feedback.

10. The method of claim 8, wherein the running the iterative learning control characterization comprises calculating a new control signal with the iterative learning control characterization.

11. The method of claim 1, wherein there is substantially no listening interval when the at least one of the marine vibrators alternates between the composite code sequences.

12. The method of claim 1, wherein each of the vibrators of the two or more of the marine vibrators that operate contemporaneously for at least one output interval alternate between composite code sequences that are unique with respect to composite code sequences.

13. A system, comprising:
a plurality of marine vibrators, wherein at least one of the marine vibrators is operable to emit a plurality of composite code sequences that are unique;
a signal generator operable to generate the composite code sequences that are unique; and
a control system operable to actuate the marine vibrators contemporaneously for at least one output interval and measure seismic data from the plurality of marine vibrators.

14. The system of claim 13, wherein at least one of the composite code sequences comprises at least one sequence selected from the group consisting of a maximal-length-type code sequence, a Gold-type code sequence, or a Kasami-type code sequence.

15. The system of claim 13, further comprising a survey vessel for towing the marine vibrators; and a sensor streamer towable from the survey vessel.

16. The system of claim 13, wherein the composite code sequences comprises composite code sequences generated by a combination of maximal linear sequences.

17. The system of claim 13, wherein the plurality of marine vibrators comprise a plurality of low frequency marine vibrators and a plurality of high frequency marine vibrators, wherein the plurality of low frequency marine vibrators operate at a frequency band that is lower than a frequency band of the plurality of high frequency marine vibrators, wherein the low frequency marine vibrators repeatedly cycle through a plurality of composite code sequences that are unique to the low frequency marine vibrators.

18. The system of claim 17, wherein the plurality of low frequency marine vibrators and the plurality of high frequency marine vibrators operate contemporaneously.

19. The system of claim 13, wherein there is substantially no listening interval when at least one of the plurality of marine vibrators alternates between the composite code sequences.

20. A method of manufacturing a geophysical data product, comprising:
towing a plurality of marine vibrators in a body of water;
operating the plurality of marine vibrators in a frequency band of from about 1 Hz to about 300 Hz, wherein at least one of the marine vibrators cycles repeatedly through a plurality of composite code sequences that are unique to the at least one of the marine vibrators, wherein two or more of the marine vibrators operate contemporaneously for at least one output interval, wherein two or more of the marine vibrators operate contemporaneously for at least one output interval; and
detecting seismic energy with one or more seismic sensors after the seismic energy has interacted with subsurface formations, wherein the seismic energy was emitted from the marine vibrators, wherein the detecting occurs while operating the plurality of marine vibrators; and
recording the detected seismic energy on one or more non-transitory, tangible computer-readable media thereby creating a geophysical data product.

21. The method of claim 20, further comprising importing the geophysical data product onshore and performing further data processing or geophysical analysis on the geophysical data product.

22. The method of claim 20, wherein at least one of the composite code sequences comprises at least one sequence selected from the group consisting of a maximal-length-type code sequence, a Gold-type code sequence, or a Kasami-type code sequence.
